(19) United States
(12) Patent Application Publication
(10) Pub. No.: US 2004/0065618 A1
(43) Pub. Date: Apr. 8, 2004

(54) Purification process

(76) Inventors: Ghaham Walter Ketley, Farnham (GB); Wei Liu, New York, NY (US); William Reagan, Dupage, IL (US)

Correspondence Address: Nixon & Vanderhye, 8th Floor, 1100 North Glebe Road, Arlington, VA, 22201-4714, US

(21) Appl. No.: 10/468,232

(22) PCT Filed: Feb. 6, 2002
(86) PCT No.: PCT/GB02/00504

(51) Int. Cl. C10G 25/02; C10G 29/04; B01D 15/00

(52) U.S. Cl. 210/660; 208/246; 208/299; 502/304

(57) ABSTRACT

The present invention provides a solid adsorbent comprising at least two metals located upon a support wherein at least one first metal is copper and at least one second metal is cerium and a process for reducing the sulphur content of a crude oil distillate feed containing sulphur species which process comprises contacting said distillate with the solid adsorbent to produce a sulphur containing adsorbent and a distillate product of reduced sulphur content.

This invention relates to a purification process, in particular one to remove sulphur compounds from hydrocarbon fuels.

Current legislation in many parts of the world for hydrocarbon fuels, such as gasoline and middle distillates e.g. diesel, requires upper limits on the content of sulphur compounds in the fuel for environmental reasons. The main commercial processes used to lower the content of sulphur compounds involve hydrotreatment of the fuel with a high sulphur level in the presence of hydrogen and a hydrotreating catalyst. It is progressively more difficult to remove the S compounds as one moves along the sequence hydrogen sulphide, mercaptans, sulphides through to thiophenes and benzothiophenes especially dibenzothiophenenes, especially hindered alkyl substituted dibenzothiophenes; the latter's reduction requires much more severe conditions, which impairs the economics of the process.

There is a continual requirement to improve desulphurisation processes to produce hydrocarbon fuels with lower sulphur content.

The present invention provides a solid adsorbent comprising at least two metals located upon a support wherein at least one first metal is copper and at least one second metal is cerium.

The invention also provides a process for reducing the sulphur content of a crude oil distillate feed containing sulphur species wherein the process comprises contacting said distillate with the solid adsorbent to produce a sulphur containing adsorbent and a distillate product of reduced sulphur content.

The metals of the adsorbent are usually located upon a porous support. The

support may be amorphous or may possess a crystalline structure or may have both amorphous and crystalline portions. The supports may be mesoporous supports which typically have average surface areas of 20-400 m²/g in particular 50-300 m²/g and especially 100-200 m²/g e.g. 150 m²/g (as measured by the BET method). The mesoporous supports have pore widths of greater than 2 nm preferably between 2-30 nm and most preferably between 5-20 nm e.g. 10-15 nm. Typically at least 20% of the pores e.g. at least 50% are within the preferred pore width ranges, preferably between 50-100% most preferably between 60-100% and especially between 80-100%.

Alternatively the supports may be microporous. Microporous supports typically have high surface areas. The microporous support may be amorphous or may possess a crystalline structure or may have both amorphous and crystalline regions. The microporous supports usually have average surface areas of 200-2000 m²/g in particular 300-1000 m²/g and especially 400-800 m²/g e.g. 500 m²/g (as measured by the BET method). The microporous supports have pore widths of less than 2.0 nm preferably between 0.1-1.5 nm most preferably between 0.3-1.2 nm e.g. 0.5-1.0 nm. Typically at least 20% of the pores e.g. at least 50% are within the preferred pore width ranges, preferably between 50-100% most preferably between 60-100% and especially between 80-100%.

The support may be a solid oxide having surface OH groups. The support may be a solid metal oxide especially an oxide of a tri or tetravalent metal. The metal of the oxide may be a transition metal, a non transition metal or a rare earth metal. Examples of solid metal oxides include alumina, titania, cobaltic oxide, zirconia, ceria, molybdenum oxide and tungsten oxide. The support may also be a solid non metal oxide such as silica. The support may also be silica-alumina or a crystalline aluminosilicate.

Preferably the support is a zeolite or zeotype material having a structure made up of tetrahedra joined together through oxygen atoms to produce an extended network with channels of molecular dimensions. The zeolite/zeotype materials have surface SiOH and/or Al—OH groups on the external or internal surfaces. One example of a suitable zeotype material is silicalite. Silicalite is one form of a crystalline silica polymorph and the term silicalite has been designated by Union Carbide. Silicalite can exist in a number of different structural forms equivalent to those of zeolites depending upon which route it is prepared.

The zeolite may be natural e.g. analcime, chabazite, clinoptilite, erionite, mordenite, laumontite, phillipsite, gmelinite, brewsterite and faujasite or may be synthetic zeolite especially those having crystalline structures. Examples of such structures are of MEL, MFI or TON types, SUZ-4, ZSM5, 12, 23, 35 A, B, X, Y, ZSM8, ZSM11, ZSM 12, ZSM35, MCM-22, Theta-1, Beta, Omega, and SUZ-9.

SUZ-4 has the general empirical formula:

m(M_{2/a}O):X₂O₃:yYO₂

in which m is 0.5 to 1.5; M is a cation of valency a; X is a metal of valency 3 selected from aluminium, boron, gallium and iron; Y is silicon or germanium and y is at least 5. SUZ-4 is claimed and described in our published European patent application EP-A-0353915 and the disclosure of which is incorporated herein by reference.

SUZ-9 has the general empirical formula:

m(M_{2/a}O):X_{Z}O_{XZ/2}:yYO₂

in which m is 0.5 to 1.5; M is a cation of valency a; x is 2 or 3; X is a metal of valency x selected from aluminium, boron, gallium, zinc and iron; z is 2 when x is 3 and z is 1 when x is 2; Y is silicon or germanium and y is at least 2. SUZ-9 is claimed and described in our published European patent application EP-A-0526252 and the disclosure of which is incorporated herein by reference.

The zeolites typically have a silica/alumina mole ratio of between 1-50:1 preferably 2-40:1 especially 4-20:1 e.g. 5:1. The most preferred zeolites include zeolite Y and ZSM-5 and particularly a zeolite material known as ITQ6 which is described in our published PCT patent application WO 00/07722 and the disclosure of which is incorporated herein by reference.

The total weight of metal may be between 0.2-20%, preferably between 1-10% and advantageously between 2-8% by weight (as metal) based on the weight of support. The metals may be introduced to the support by any of the well known techniques employed in catalyst preparation e.g. impregnation wherein the pores of the support are filled at least partly with an impregnating solution comprising a soluble precursor salt of the desired metal and the impregnated resulting support material is subsequently dried, optionally calcined and then the metal is optionally reduced, in particular to elemental metal or alternatively oxidised. The impregnating solution is usually an aqueous solution of a metal nitrate, oxalate, formate, propionate, acetate, chloride, carbonate, or bicarbonate in particular a metal nitrate, chloride or carbonate. Alternatively the impregnating solution may comprise a metal compound dissolved in an organic solvent e.g. a metal acetylacetonates or metal naphthenates.

The metal incorporated support may be prepared by co-precipitation which comprises contacting a base e.g. ammonium bicarbonate, with a precursor solution of salts of the metal and the intended support e.g. copper(II)nitrate and aluminium nitrate. A precipitate containing the mixed hydroxides is formed and after washing, drying and calcination a mixture of oxides is formed e.g. copper (1) oxide and alumina.

Preferably the metal may be introduced to an acidic oxide support e.g. silica by ion exchange of the acidic sites with metal cations or alternatively ion exchange of the hydroxyl groups of a basic oxide support with metal containing anions. The support may then be dried, and if desired calcined and then optionally reduced or oxidised.

Most preferably the metals are introduced to the support using ion exchange wherein ions of the metals may be exchanged with the cations present within the structure of the support e.g. those present within a zeolite.

The cerium may be introduced to the support by any of the methods herein described before or after the incorporation of the copper. Alternatively the incorporation of the cerium may be simultaneous with the incorporation of the copper. Preferably the cerium is introduced before the introduction of the copper.

The support usually comprises at least 0.1% e.g. 0.1-10% preferably 0.2-5% and especially 1-3% by weight of copper (based on the weight of support) and at least 0.1% e.g. 0.1-20% preferably 0.2-10% and especially 2-6% by weight of cerium (based on the weight of support).

After metal incorporation the adsorbent may be post treated. The post treatment usually involves calcination in air, nitrogen or helium at a temperature within the range of 200-800° C., preferably 300-700° C. e.g. 350-500° C. Optionally the adsorbent may be reduced. The reduction of the adsorbent is usually conducted at a temperature within the range of 100-800° C., preferably 200-700° C. with a flowing gas such as hydrogen, carbon monoxide or a light hydrocarbon e.g. C₁-C₄ hydrocarbon or mixtures thereof.

The incorporated metals may be either present on the support in the form of ions, elemental metals or in the form of an ionic compound e.g. metal oxide.

The crude oil distillate feed is usually a liquid at a temperature of 25° C. and 1 atmosphere pressure and is generally a liquid hydrocarbon directly or indirectly derived from a crude oil distillation. It may be a middle distillate e.g. gas oil, naphtha, diesel or kerosene or a gasoline e.g. for motor or aviation use. The distillate feed usually contains saturated hydrocarbons e.g. branched and unbranched alkanes and alicyclic hydrocarbons as well as variable amounts of aromatics and/or unsaturated compounds such as olefins.

The sulphur compounds present in the feed may be hydrogen sulphide, mercaptans, thioethers, and/or heterocyclic compounds with a S ring atom, e.g. thiophene including alkylated thiophenes, benzothiophenes, including alkylated benzothiophenes and dibenzothiophene/alkylated dibenzothiophenes.

The distillate feed may have a total amount of the sulphur containing compounds of between 1000-10,000 ppm. Alternatively the distillate feed may have a total amount of the sulphur containing compounds of less than 1000 ppm e.g. 300-1000 ppm, less than 500 or 300 ppm, less than 100 ppm e.g. 50-100 ppm, less than 50 ppm e.g. 20-50 ppm or less than 10 ppm e.g. 1-10 ppm (expressed by weight as elemental S).

The process may be used to remove sulphur compounds from hydrocarbon streams and this sulphur removal may be conducted at a pipeline, at a refinery, at a terminal, or at a retail site. Alternatively the process may be used onboard a motor vehicle to remove sulphur from a fuel prior to delivery of said fuel to the engine.

In the most preferred embodiment of the invention the process may be used after a degree of sulphur has been removed from the distillate feed using a conventional sulphur removal process e.g. hydrotreating. In this embodiment the process according to the invention provides further reduction of sulphur content of the distillate feed and this known in the art as a ‘polishing stage’.

The distillate feed is preferably contacted with the adsorbent at a temperature from 0° C.-500° C., e.g. 20-350° C. or 100-400° C., and at pressure of from 1-20 bar, e.g. 5-15 bar. The distillate feed may be in the vapour or liquid phase and the adsorbent may form a fluidised bed but is preferably in the form of a fixed bed.

The adsorbent is usually in the form of a powder for fluidised beds and is usually in granular form for fixed beds. The adsorbent may also be in the form of pellets, extrudates, or spheres. The adsorbent particles preferably have a diameter within the range of 1 micron-1 cm. Alternatively the adsorbent may be deposited on a larger substrate e.g. a monolith or a foam.

The adsorbent is usually contained within a vessel in which the contact with the distillate takes place and the vessel may be one capable of withstanding temperatures of up to 500° C. and pressures of up to 20 bar, e.g. a steel pressure vessel. A reactor previously used for or designed as fluid catalytic cracker (FCC) reactor may be used as the vessel.

Alternatively the adsorbent may be contained in a tubular vessel e.g. a cartridge designed to be used as a sulphur trap within a conventional motor vehicle. In this embodiment of the invention the sulphur trap is usually capable of withstanding temperatures of up to 500° C. and pressures of up to 10 bar and the cartridge is usually capable of containing up to 5 kg of adsorbent e.g 0.1-3 kg, preferably 0.2-0.8 kg. Generally the sulphur trap is located in series between the fuel pump and the engine.

In a preferred embodiment of the invention the sulphur trap is used on board a motor vehicle which is powered by a fuel cell which comprises a fuel processor which converts hydrocarbon fuel to hydrogen. The sulphur trap is advantageously located such that sulphur compounds are removed from the hydrocarbon fuel prior to contacting the fuel processor.

When the adsorbent is used within a sulphur trap on board a motor vehicle the hydrocarbon preferably contacts the adsorbent in the liquid phase and the adsorbent is usually in the form of a fixed bed.

The contact of the adsorbent with the hydrocarbon may be in the presence of inert gas e.g. nitrogen or helium and when the hydrocarbon is in the vapour phase it may be contacted with the adsorbent in the presence of hydrogen. This hydrogen may be used to inhibit coking of the adsorbent, in particular in a fixed bed process.

The process may be operated as a batch process or a continuous process and the ratio of distillate feed to adsorbent may be in the range of 0.1-1000:1 e.g. 10-1000:1.

In a continuous process employing a fixed bed adsorbent the process is usually continued until the adsorbent no longer reduces the sulphur level of the distillate feed to the chosen value, i.e. until sulphur breakthrough. In a batch process, the process is usually continued for a predesignated period of time.

The distillate product of reduced sulphur content may contain a total amount of the sulphur containing compounds of less than 500 ppm e.g. 200-400 ppm, less than 200 ppm e.g. 50-100 ppm, less than 50 ppm e.g. 20-40 ppm or less than 10 ppm e.g. 0.1-5 ppm (expressed by weight as elemental S). Preferably the distillate product of reduced sulphur content contains 0 ppm of sulphur.

When the adsorbent is located in a sulphur trap, the trap can be designed to have a lifetime such that the required sulphur removal is provided for between 50 h-10000 h prior to sulphur breakthrough. Typically the distillate product of reduced sulphur content contains less than 50 ppm e.g. 20-40 ppm or less than 10 ppm e.g. 0.1-5 ppm (expressed by weight as elemental S). The estimated lifetime of sulphur trap for use on board a conventional motor vehicle or a motor vehicle powered by a fuel cell may advantageously be designed to coincide with service intervals.

In a further embodiment of the invention the process comprises at least partially separating said distillate product of reduced sulphur content from said sulphur containing adsorbent and treating said sulphur containing adsorbent with a stripping medium to effect stripping of sulphur compounds from said sulphur containing adsorbent to produce an adsorbent of reduced or zero sulphur content and a stripping medium contaminated with sulphur compounds. The adsorbent of reduced or zero sulphur content may then be used in the sulphur removal operation.

The sulphur containing adsorbent is preferably stripped of its sulphur content by contact with a stripping gas e.g. nitrogen, oxygen, hydrogen or steam or a sulphur free hydrocarbon gas to give a solid substantially free of adsorbed sulphur compounds. The sulphur containing adsorbent is usually contacted with the stripping gas at a temperature elevated above the temperature of adsorption. Usually the stripping gas is contacted with the adsorbent at temperatures in the range of 100-600° C. e.g. 150-350° C. with the stripping gas at 1-100 bar pressure.

When the adsorbent is located in the sulphur trap it may be provided with a regenerating system wherein the trap is heated after adsorption to remove the adsorbed sulphur.

The invention is illustrated in the following examples.

### EXAMPLE 1

Preparation of Adsorbent

A Y zeolite powder namely that sold under the registered trade mark CBV500 which contained a silica/alumina mole ratio of 5.2:1 was loaded with 1.52% by weight of copper and 3.4% by weight of ceria using ion exchange. The powder was then dried pelleted/ground to 20/40 mesh and calcined by raising the temperature at a rate of 2.8° C./min to 482° C. and maintaining the adsorbent at that temperature for 2 h. Prior to testing it was activated in nitrogen at 200° C. for 12 h.

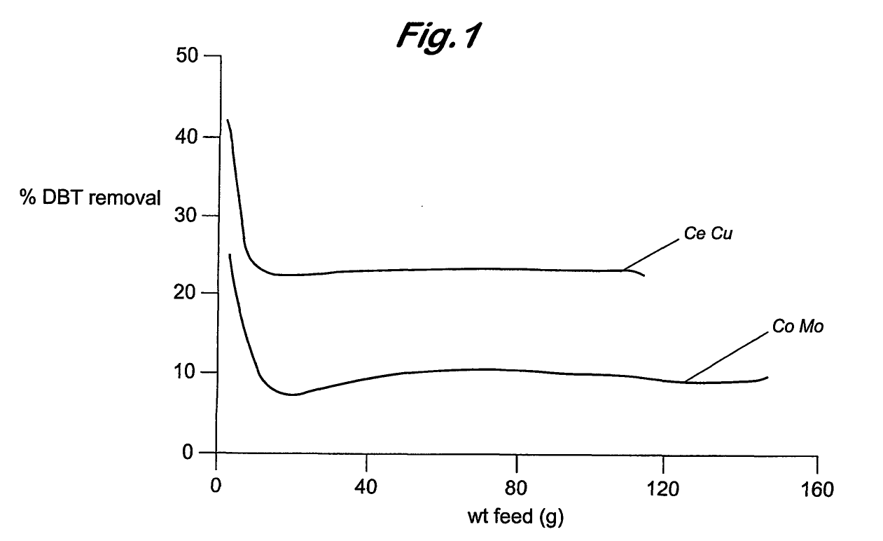

1.11 g of the adsorbent was placed in a reactor column and diesel comprising 53 ppm of dibenzothiophenes (expressed by weight as elemental S) was passed over the adsorbent at 1 ml/min. The inlet pressure of the column was 12 bar and the outlet pressure was 7 bar. The adsorbent temperature was 340° C. The % of sulphur removal was then monitored at various intervals and the results are shown in Table 1a and FIG. 1.

### COMPARATIVE EXAMPLE

2.07 g of a CoMo catalyst namely that sold under registered trade mark Akzo Nobel KF-757 was placed in the above column and diesel comprising 53 ppm of dibenzothiophenes (expressed by weight as elemental S) was passed over the adsorbent at 1 ml/min. The inlet pressure of the column was 10 bar and the outlet pressure was 7 bar. The catalyst temperature was 340° C. The % of sulphur removal was monitored at various intervals and the results are shown in Table 1b FIG. 1.

### EXAMPLE 2

The adsorbent of Example 1 was calcined and activated in nitrogen at 340° C. for 1 h.

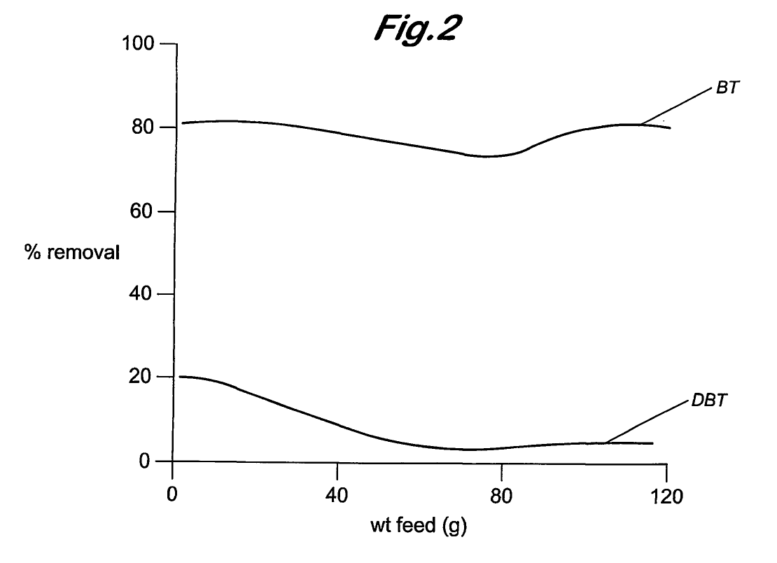

1.12 g of the adsorbent was placed in a reactor column and diesel comprising 42 ppm of sulphur (expressed by weight as elemental S) was passed over the adsorbent at 1 ml/min. The inlet pressure of the column was 10 bar and the outlet pressure was 7 bar and the adsorbent temperature was 340° C. The sulphur content comprised 25.3 ppm of benzothiopenes and 16.7 ppm of dibenzothiopenes (expressed by weight as elemental S). The % of dibenzothiopenes and benzothiopenes removed was monitored at various intervals and the results are shown in Table 2 and FIG. 2.

### EXAMPLE 3

The adsorbent of Example 1 was calcined and activated in nitrogen at 200° C. for 16 h.

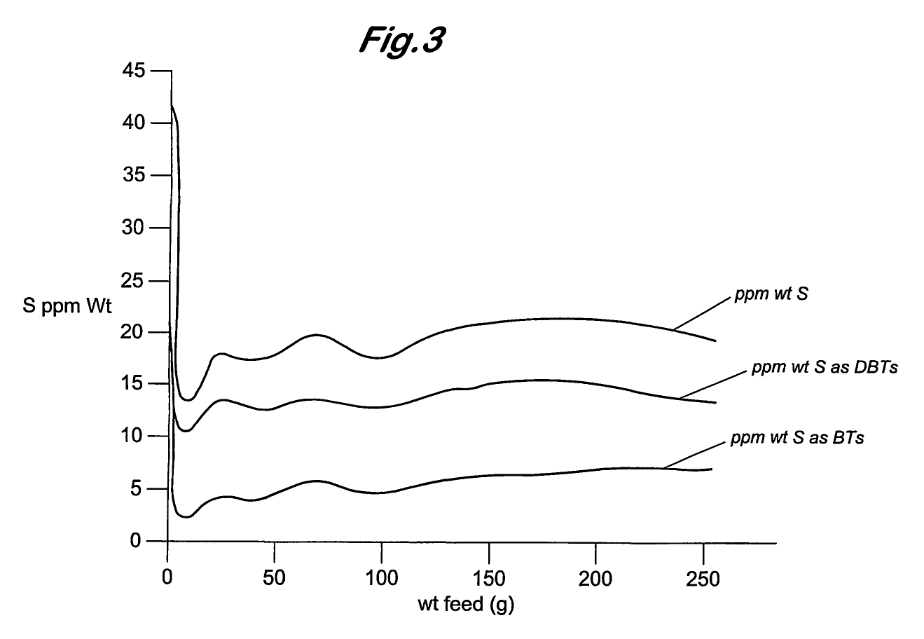

1.10 g of the adsorbent was placed in a reactor column and diesel comprising 42 ppm of sulphur (expressed by weight as elemental S) was passed over the adsorbent at 1 ml/min. The inlet pressure of the column was 9 bar and the outlet pressure was 7 bar and the adsorbent temperature was 340° C. The sulphur content comprised 22.3 ppm of benzothiopenes and 19.7 ppm of dibenzothiopenes (expressed by weight as elemental S). The dibenzothiopenes and benzothiopenes content was monitored at various intervals and the results are shown in Table 3 and FIG. 3.

### EXAMPLE 4

The adsorbent of Example 1 was calcined and activated in nitrogen at 200° C. for 2 h.

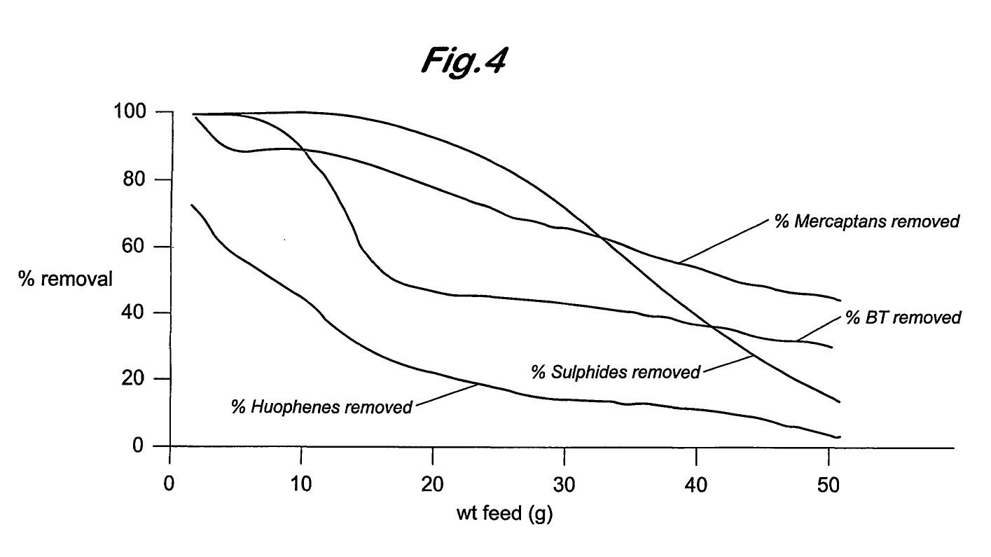

0.29 g of the adsorbent was placed in a reactor column and gasoline comprising 31.5 ppm (expressed by weight as elemental S) was passed over the adsorbent at 0.5 ml/min. The inlet pressure of the column was 9 bar and the outlet pressure was 7 bar and the adsorbent temperature was 180° C. The sulphur content comprised 5.2 ppm of mercaptans, 10.4 ppm of sulphides, 10.9 ppm of thiophenes and 5 ppm benzothiopenes (expressed by weight as elemental S). The % of mercaptans, sulphides, thiophenes and benzothiopenes removed was monitored at various intervals and the results are shown in Table 4 and FIG. 4.

TABLE 1a
Example 1

| Wt Feed (g) passed over adsorbent | % DET removed |
|---|---|
| 3.8 | 41 |
| 11.6 | 23 |
| 33.3 | 23 |
| 60.4 | 23 |
| 117.3 | 23 |

TABLE 1b
Comparative Example 1

| Wt Feed (g) passed over adsorbent | % DBT removed |
|---|---|
| 4.4 | 24 |
| 15.4 | 8 |
| 47.9 | 9 |
| 101.2 | 9 |
| 154.5 | 0 |

TABLE 2
Example 2

| Wt Feed (g) passed over | | |
|---|---|---|
| adsorbent | % BT removed | % DBT removed |
| 3.5 | 85.8 | 22 |
| 20.5 | 86.2 | 20 |
| 47.7 | 77.5 | 6 |
| 69.6 | 68.8 | 4 |
| 88.8 | 81.8 | 10 |
| 110.6 | 75.9 | 7 |

TABLE 3
Example 3

| Wt Feed (g) passed over | | | |
|---|---|---|---|
| adsorbent | ppmwtS | ppmwtS as BT | ppmwtS as DBT |
| 5.3 | 13.1 | 2.6 | 10.5 |
| 22.2 | 18.1 | 4.4 | 13.7 |
| 45.4 | 17.0 | 4.4 | 12.6 |
| 66.0 | 20.0 | 5.9 | 14.1 |
| 94.2 | 17.3 | 4.8 | 12.5 |
| 115.0 | 19.3 | 5.5 | 13.8 |
| 143.3 | 21.1 | 6.3 | 14.8 |
| 148.0 | 21.5 | 6.3 | 15.2 |
| 197.1 | 21.7 | 6.6 | 15.1 |
| 254.8 | 19.5 | 6.1 | 13.4 |

TABLE 4
Example 4

| | % | % | % | |
|---|---|---|---|---|
| Wt Feed (g) passed | Mercaptans | Sulphides | Thiophenes | % BT |
| over adsorbent | removed | removed | removed | removed |
| 1.32 | 100.0 | 100.0 | 71.7 | 100.0 |
| 3.83 | 90.1 | 100.0 | 65.2 | 100.0 |
| 9.33 | 92.4 | 100.0 | 46.2 | 92.4 |
| 15.56 | 84.8 | 98.7 | 28.0 | 52.3 |
| 25.37 | 73.0 | 83.7 | 17.7 | 45.1 |
| 35.99 | 60.7 | 48.8 | 11.2 | 39.0 |
| 51.23 | 42.6 | 11.5 | 1.5 | 30.3 |

1. A solid adsorbent comprising at least two metals located upon a support wherein at least one first metal is copper and at least one second metal is cerium.

2. A solid adsorbent according to claim 1 wherein the support is a solid metal oxide selected from alumina, titania, cobaltic oxide, zirconia, ceria, molybdenum oxide and tungsten oxide.

3 A solid adsorbent according to claim 1 wherein the support is a solid non metal oxide.

4. A solid adsorbent according to claim 3 wherein the support is silica.

5. A solid adsorbent according to claim 1 wherein the support is silica-alumina or a crystalline aluminosilicate.

6. A solid adsorbent according to claim 1 wherein the support is a zeolite or zeotype material.

7. A solid adsorbent according to claim 6 wherein the support is a zeolite material known as ITQ6.

8. A solid adsorbent according to anyone of the preceeding claims wherein the total weight of metal when the metal is supported is between 0.2-20% by weight (as metal) based on the weight of support.

9. A solid adsorbent according to claim 8 wherein the support comprises 0.2-5% by weight of copper and 0.2-10% by weight of cerium (based on the weight of support).

10. A solid adsorbent according to claim 9 wherein the support comprises 1-3% by weight of copper and 2-6% by weight of cerium (based on the weight of support).

11. A process for reducing the sulphur content of a crude oil distillate feed containing sulphur species which process comprises contacting said distillate with a solid adsorbent according to anyone of the preceeding claims to produce a sulphur containing adsorbent and a distillate product of reduced sulphur content.

12. A process according to claim 11 wherein the distillate feed is a liquid at a temperature of 25° C. and 1 atmosphere pressure.

13. A process according to claim 12 wherein the distillate feed is a middle distillate e.g. diesel, kerosene or gasoline.

14. A process according to anyone of claims 11-13 wherein the distillate feed is contacted with the adsorbent at a temperature of between 200-400° C. and at pressure of between 1-20 bar.

15. A sulphur trap comprising a cartridge containing 0.1-5 kg of adsorbent as claimed in claims 1-10.
